(19) United States
(12) Patent Application Publication
(10) Pub. No.: US 2026/0229790 A1
(43) Pub. Date: Aug. 6, 2026

(54) MAGNETO-ELECTRIC DIPOLE ANTENNA AND ANTENNA ARRAY

(71) Applicant: Alpha Networks Inc., Hsinchu (TW)

(72) Inventor: Pao-Wei LIN, Hsinchu (TW)

(21) Appl. No.: 19/212,211

(22) Filed: May 19, 2025

(30) Foreign Application Priority Data
Feb. 6, 2025 (TW) 114104293

(51) Int. Cl. H01Q 21/06; H01Q 9/04; H01Q 9/18

(52) U.S. Cl. CPC H01Q 21/065; H01Q 9/0407; H01Q 9/18

(57) ABSTRACT

A magneto-electric dipole antenna includes an antenna module, and a substrate module that has a ground layer inside. The antenna module includes a first electric dipole component disposed above the substrate module, a second electric dipole component and a magnetic dipole component disposed in the substrate module, a first feed-in component and a second feed-in component. The magnetic dipole component is connected to the first electric dipole component, the second electric dipole component and the ground layer. Each of the first and second feed-in components includes a feed-in probe, a feed-in line disposed below the substrate module, and a connecting element disposed in the substrate module and connecting the feed-in probe and the feed-in line. The feed-in probe of the first feed-in component is disposed above the substrate module. The feed-in probe of the second feed-in component is disposed in the substrate module.

### CROSS-REFERENCE TO RELATED APPLICATION

This application claims priority to Taiwanese Invention patent application No. 114104293, filed on Feb. 6, 2025, the entire disclosure of which is incorporated by reference herein.

### FIELD

The disclosure relates to a magneto-electric dipole antenna and an antenna array, and more particularly to a magneto-electric dipole antenna and an antenna array that are adapted for low-earth orbit satellite communication.

### BACKGROUND

For low-earth orbit (LEO) satellite communication, a conventional antenna operating in the K-band (18 GHZ-27 GHZ) is designed dedicatedly for one of the transmitting end (Tx) and the receiving end (Rx), and the radio frequency (RF) signal is directly fed to the radiative component of the conventional antenna through a conductive via of the conventional antenna. Although the conventional antenna is easy to manufacture, the operating frequency band of the conventional antenna may fail to fully cover a frequency range of 17.7 GHZ to 21.2 GHZ. Moreover, the radiation pattern of the conventional antenna may be relatively asymmetric, which may limit the receiving efficiency of the conventional antenna.

### SUMMARY

Therefore, an object of the disclosure is to provide a magneto-electric dipole antenna and an antenna array that can alleviate at least one of the drawbacks of the prior art.

According to an aspect of the disclosure, a magneto-electric dipole antenna includes a substrate module and an antenna module. The substrate module includes an upper surface, a lower surface, and a ground layer that is disposed between the upper surface and the lower surface. The antenna module includes a first electric dipole component that is disposed on the upper surface of the substrate module, a second electric dipole component that is disposed between the upper surface and the ground layer in the substrate module, a magnetic dipole component, a first feed-in component and a second feed-in component. The magnetic dipole component is disposed between the upper surface and the ground layer in the substrate module, and is electrically connected to the first electric dipole component, the second electric dipole component and the ground layer. The first feed-in component includes a first feed-in probe that is disposed on the upper surface of the substrate module, a first feed-in line that is disposed on the lower surface of the substrate module, and a first connecting element that is disposed in the substrate module and that electrically connects the first feed-in probe and the first feed-in line. The second feed-in component includes a second feed-in probe that is disposed in the substrate module on a plane at which the second electric dipole component is disposed, a second feed-in line that is disposed on the lower surface of the substrate module, and a second connecting element that is disposed in the substrate module and that electrically connects the second feed-in probe and the second feed-in line.

According to another aspect of the disclosure, an antenna array includes a plurality of magneto-electric dipole antennas that are arranged as an array, where polarizations of two adjacent ones of the magneto-electric dipole antennas are orthogonal to each other.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary perspective view illustrating a magneto-electric dipole antenna according to an embodiment of the disclosure.

FIG. 2 is an exploded perspective view of the magneto-electric dipole antenna according to the embodiment.

FIG. 3 is a top view of the magneto-electric dipole antenna according to the embodiment.

FIG. 4 is a sectional view taken along line IV-IV in FIG. 3, illustrating the magneto-electric dipole antenna according to the embodiment.

FIG. 5 is a plot illustrating various scattering parameters (S parameters) of the magneto-electric dipole antenna according to the embodiment when operating in a predetermined frequency range.

FIG. 6 is a plot illustrating a gain of the magneto-electric dipole antenna according to the embodiment when operating in the predetermined frequency range.

FIG. 7 is a plot illustrating an axial ratio of the magneto-electric dipole antenna according to the embodiment when operating in the predetermined frequency range.

FIG. 8 depicts two plots illustrating radiation patterns of the magneto-electric dipole antenna according to the embodiment when operating at a predetermined frequency.

FIG. 9 is a top view illustrating an antenna array according to another embodiment of the disclosure.

FIG. 10 is a plot illustrating various scattering parameters (S parameters) of the antenna array according to the another embodiment when operating in the predetermined frequency range.

FIG. 11 is a plot illustrating a gain of the antenna array according to the another embodiment when operating in the predetermined frequency range.

FIG. 12 is a plot illustrating an axial ratio of the antenna array according to the another embodiment when operating in the predetermined frequency range.

FIG. 13 depicts two plots illustrating radiation patterns of the antenna array according to the another embodiment when operating at the predetermined frequency.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

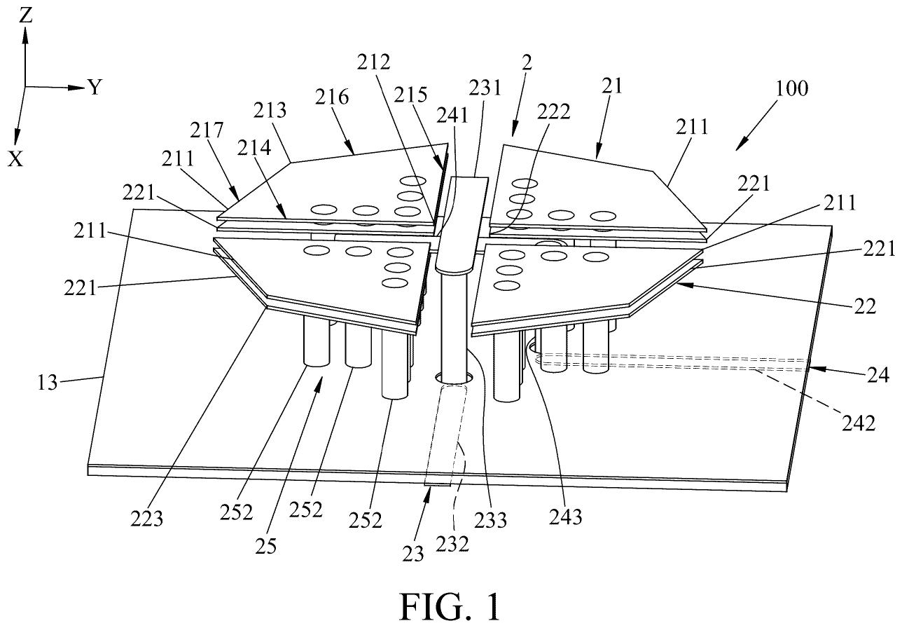

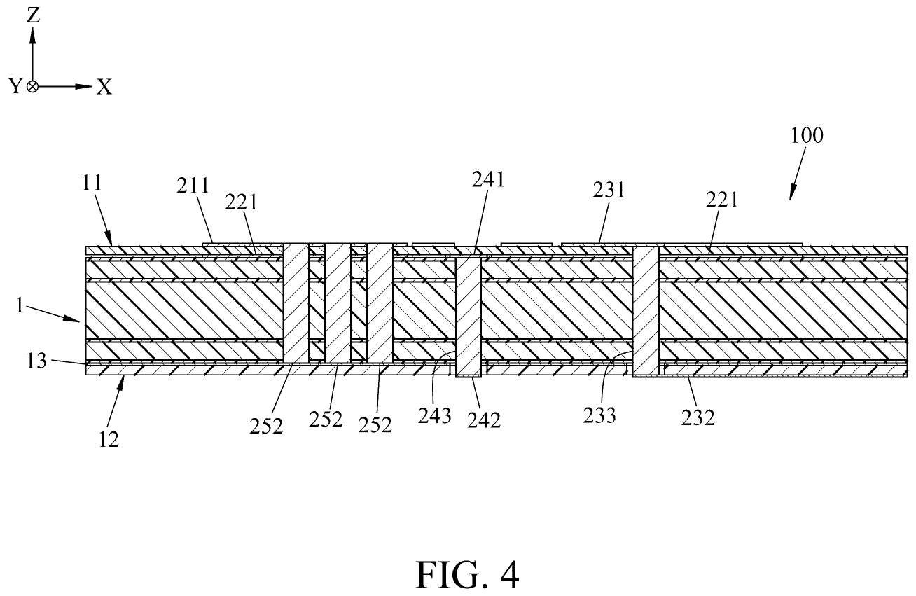

Referring to FIGS. 1 to 4, a magneto-electric dipole antenna 100 according to an embodiment of the disclosure is provided. In this embodiment, the magneto-electric dipole antenna 100 is adapted to operate in a frequency range (i.e., an operating frequency band) around and covering a target frequency. The operating frequency band approximately ranges from 17.7 GHZ to 21.2 GHZ, and the target frequency is a center frequency of the operating frequency band (i.e., approximately 19.45 GHZ).

In this embodiment, the magneto-electric dipole antenna 100 includes a substrate module 1 and an antenna module 2. The substrate module 1 includes an upper surface 11, a lower surface 12 that is opposite to the upper surface 11, and a ground layer 13 that is disposed in the substrate module 1 between the upper surface 11 and the lower surface 12. The antenna module 2 includes a first electric dipole component 21, a second electric dipole component 22, a first feed-in component 23, a second feed-in component 24, and a magnetic dipole component 25.

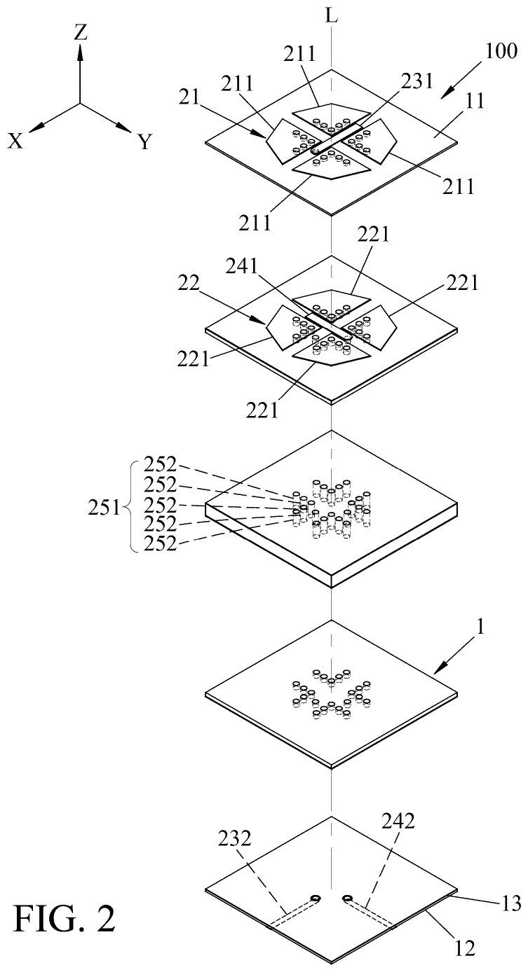

The first electric dipole component 21 is disposed on the upper surface 11 of the substrate module 1, and includes four first patches 211 that are divided into a first patch pair and a second patch pair. Two of the first patches 211 in the first patch pair are spaced apart and are arranged along a first direction (X) that is parallel to the upper surface 11 of the substrate module 1. Another two of the first patches 211 in the second patch pair are spaced apart and are arranged along the first direction (X). Specifically, the first patch pair and the second patch pair are spaced apart and are arranged along a second direction (Y) that is parallel to the upper surface 11 of the substrate module 1 and that is perpendicular to the first direction (X) (as shown in FIG. 2). In some embodiments, a quantity of the first patches 211 may be other than four according to user needs.

Each of the first patches 211 includes a first corner 212 and a second corner 213 that align with a first imaginary line which passes through a center point of the upper surface 11 of the substrate module 1 and which is parallel to the upper surface 11 of the substrate module 1. The first corner 212 is closer to the center point of the upper surface 11 of the substrate module 1 than is the second corner 213. To configure the magneto-electric dipole antenna 100 to operate in the frequency range that covers the target frequency, a distance between the first corner 212 and the second corner 213 is designed to be substantially equal to a first formula as follows:

$$\frac{c}{4 f \sqrt{{ε}_{r}}} , \qquad ( formula 1 )$$

where “c” represents a speed of light, “f” represents the target frequency, and “εᵣ” represents a dielectric constant of the substrate module 1.

In this embodiment, the first electric dipole component 21 has a shape of an octagon. Moreover, each of the first patches 211 of the first electric dipole component 21 further includes a first edge 214 and a second edge 215 that are connected to each other through the first corner 212, and further includes a third edge 216 and a fourth edge 217 that are connected to each other through the second corner 213. Specifically, for each of the first patches 211, a first angle of the first patch 211 formed by the first edge 214 and the second edge 215 at the first corner 212 is equal to 90 degrees, and a second angle of the first patch 211 formed by the third edge 216 and the fourth edge 217 at the second corner 213 is equal to 135 degrees. In some embodiments, the first electric dipole component 21 has a shape of a circle, or other suitable shapes.

The second electric dipole component 22 is disposed between the upper surface 11 and the ground layer 13 in the substrate module 1, and includes four second patches 221 that are divided into a third patch pair and a fourth patch pair. Two of the second patches 221 in the third patch pair are spaced apart and are arranged along the second direction (Y). Another two of the second patches 221 in the fourth patch pair are spaced apart and are arranged along the second direction (Y). Specifically, the third patch pair and the fourth patch pair are spaced apart and are arranged along the first direction (X) (as shown in FIG. 2). In some embodiments, a quantity of the second patches 221 may be other than four according to user needs.

The second electric dipole component 22 is identical in size and shape to the first electric dipole component 21 (i.e., in this embodiment, the second electric dipole component 22 has a shape of an octagon). Similar to the first electric dipole component 21, each of the second patches 221 includes a third corner 222 and a fourth corner 223, where the third corner 222 is closer to the center point of the upper surface 11 of the substrate module 1 than is the fourth corner 223, and a distance between the third corner 222 and the fourth corner 223 is substantially equal to the first formula as described above.

The first feed-in component 23 includes a first feed-in probe 231 that is disposed on the upper surface 11 of the substrate module 1, a first feed-in line 232 that is disposed on the lower surface 12 of the substrate module 1, and a first connecting element 233 that is disposed in the substrate module 1 and that electrically connects the first feed-in probe 231 and the first feed-in line 232. The first feed-in probe 231 extends along the first direction (X) and is disposed between the first patch pair and the second patch pair of the first electric dipole component 21. The first feed-in line 232 also extends along the first direction (X).

The second feed-in component 24 includes a second feed-in probe 241 that is disposed in the substrate module 1 on a plane at which the second electric dipole component 22 is disposed, a second feed-in line 242 that is disposed on the lower surface 12 of the substrate module 1, and a second connecting element 243 that is disposed in the substrate module 1 and that electrically connects the second feed-in probe 241 and the second feed-in line 242. The second feed-in probe 241 extends along the second direction (Y) and is disposed between the third patch pair and the fourth patch pair of the second electric dipole component 22. The second feed-in line 242 also extends along the second direction (Y).

It should be noted that a geometric center of the first electric dipole component 21, a geometric center of the second electric dipole component 22, a geometric center of the first feed-in probe 231, and a geometric center of the second feed-in probe 241 are all aligned on a second imaginary line (L) that is perpendicular to the upper surface 11 of the substrate module 1 (as shown in FIG. 2).

The magnetic dipole component 25 includes a plurality of magnetic dipole sets 251 (e.g., four sets) that respectively correspond to the first patches 211, and that respectively correspond to the second patches 221. Specifically, each of the magnetic dipole sets 251 includes five conducting rods 252 that is disposed between the upper surface 11 and the ground layer 13 in the substrate module 1. Each of the conducting rods 252 is perpendicular to the upper surface 11 of the substrate module 1, extends in a direction (i.e., opposite to a third direction (Z) that is perpendicular to the first direction (X) and the second direction (Y)) away from the upper surface 11 of the substrate module 1, and is electrically connected to a corresponding one of the first patches 211, a corresponding one of the second patches 221, and the ground layer 13. It should be noted that a quantity of the conducting rods 252 in each of the magnetic dipole sets 251 is not limited to five, and in some embodiments, the quantity of the conducting rods 252 may be one, two, three, four, six, or more.

It should be further noted that, for each of the magnetic dipole sets 251, the conducting rods 252 are disposed at a vicinity of the first corner 212 that is of the corresponding one of the first patches 211, and are disposed at a vicinity of the third corner 222 that is of the corresponding one of the second patches 221, where the first corner 212 is one of a plurality of corners of the corresponding one of the first patches 211 that is the closest to the geometric center of the first electric dipole component 21, and the third corner 222 is one of a plurality of corners of the corresponding one of the second patches 221 that is the closest to the geometric center of the second electric dipole component 22. To configure the magneto-electric dipole antenna 100 to operate in the frequency range that covers the target frequency, a length of each of the conducting rods 252 is substantially equal to the first formula as described above.

In some embodiments, the magneto-electric dipole antenna 100 includes an M1 layer, an H1 layer, an M2 layer, a PP1 layer, an H2 layer, a PP2 layer, an H3 layer, a PP3 layer, an H4 layer, a PP4 layer, an M3 layer, an H5 layer and an M4 layer that are stacked from top to bottom in the given order, as shown in FIGS. 1 to 4, and Table 1 as below. Table 1 includes the material, the thickness, and the dielectric constant for each of the layers mentioned above.

TABLE 1

| Layer | Material | Thickness (mm) | Dielectric constant |
|---|---|---|---|
| M1 | Copper | 0.035 | — |
| H1 | NPG-199K | 0.127 | 3.25 |
| M2 | Copper | 0.035 | — |
| PP1 | NPG-199K | 0.050 | 3.25 |
| H2 | NPG-199K | 0.254 | 3.25 |
| PP2 | NPG-199K | 0.050 | 3.25 |
| H3 | NPG-188H | 0.800 | 3.70 |
| PP3 | NPG-199K | 0.050 | 3.25 |
| H4 | NPG-199K | 0.254 | 3.25 |
| PP4 | NPG-199K | 0.050 | 3.25 |
| M3 | Copper | 0.035 | — |
| H5 | NPG-199K | 0.127 | 3.25 |
| M4 | Copper | 0.035 | — |

The M1 layer includes the first patches 211 of the first electric dipole component 21 and the first feed-in probe 231 of the first feed-in component 23. The M2 layer includes the second patches 221 of the second electric dipole component 22 and the second feed-in probe 241 of the second feed-in component 24. The M3 layer includes the ground layer 13 of the substrate module 1. The M4 layer includes the first feed-in line 232 of the first feed-in component 23 and the second feed-in line 242 of the second feed-in component 24. The H1 layer, the H2 layer, the H4 layer, the H5 layer, the PP1 layer, the PP2 layer, the PP3 layer and the PP4 layer (which are made of NPG-199K) and the H3 layer (which is made of NPG-188H) are dielectric materials that are suitable for forming the substrate module 1, and the PP1 layer, the PP2 layer, the PP3 layer and the PP4 layer are used for sticking the H1 layer, the H2 layer, the H3 layer, the H4 layer and the H5 layer together.

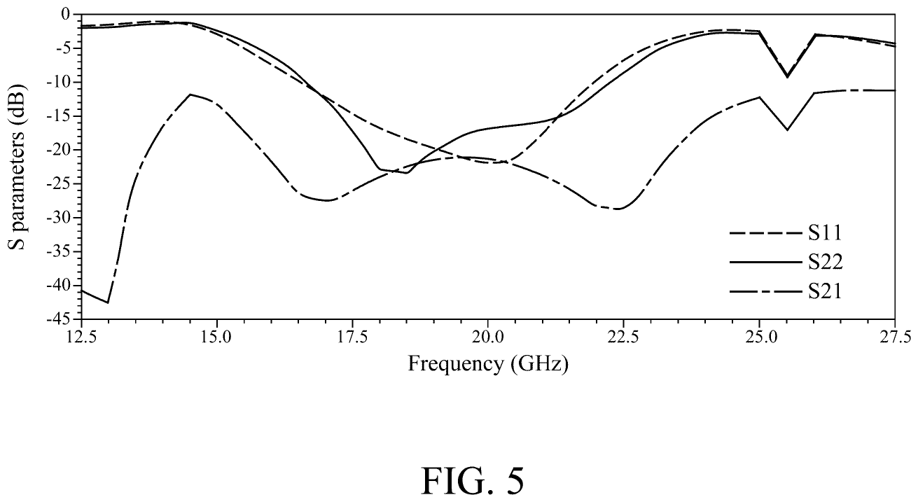

FIG. 5 is a plot illustrating scattering parameters (S11, S21, and S22) of the magneto-electric dipole antenna 100 of this embodiment in a predetermined frequency range of 12.5 GHz to 27.5 GHz. The scattering parameter (S11) is a reflection coefficient at the first feed-in line 232, and is smaller than a target value of the scattering parameter (S11) (e.g., −10 dB) in the operating frequency band (i.e., 17.7 GHZ to 21.2 GHZ) of the magneto-electric dipole antenna 100. The scattering parameter (S21) is a transmission coefficient that is related to isolation between the first feed-in line 232 and the second feed-in line 242, and is smaller than a target value of the scattering parameter (S21) (e.g., −20 dB) in the operating frequency band of the magneto-electric dipole antenna 100. The scattering parameter (S22) is a reflection coefficient at the second feed-in line 242, and is smaller than a target value of the scattering parameter (S22) (e.g., −10 dB) in the operating frequency band of the magneto-electric dipole antenna 100.

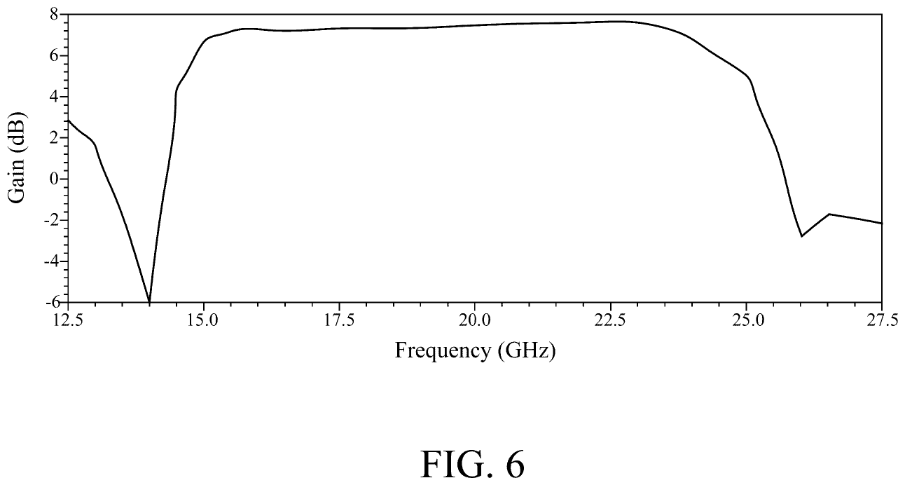

FIG. 6 is a plot illustrating a gain of the magneto-electric dipole antenna 100 of this embodiment in the predetermined frequency range (i.e., 12.5 GHz to 27.5 GHZ), where the gain of the magneto-electric dipole antenna 100 is greater than 6 dB in the operating frequency band (17.7 GHZ to 21.2 GHZ) of the magneto-electric dipole antenna 100.

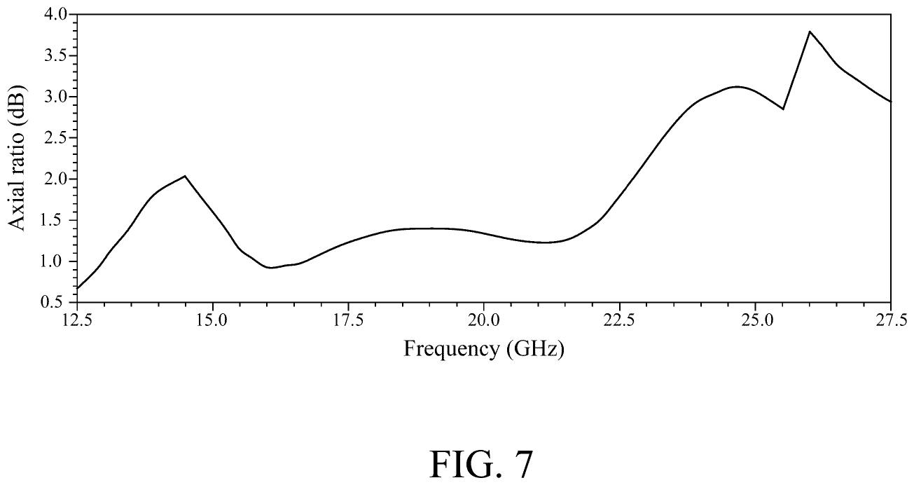

FIG. 7 is a plot illustrating an axial ratio of the magneto-electric dipole antenna 100 of this embodiment in the predetermined frequency range, where the axial ratio of this embodiment is smaller than 1.5 dB in the operating frequency band of the magneto-electric dipole antenna 100.

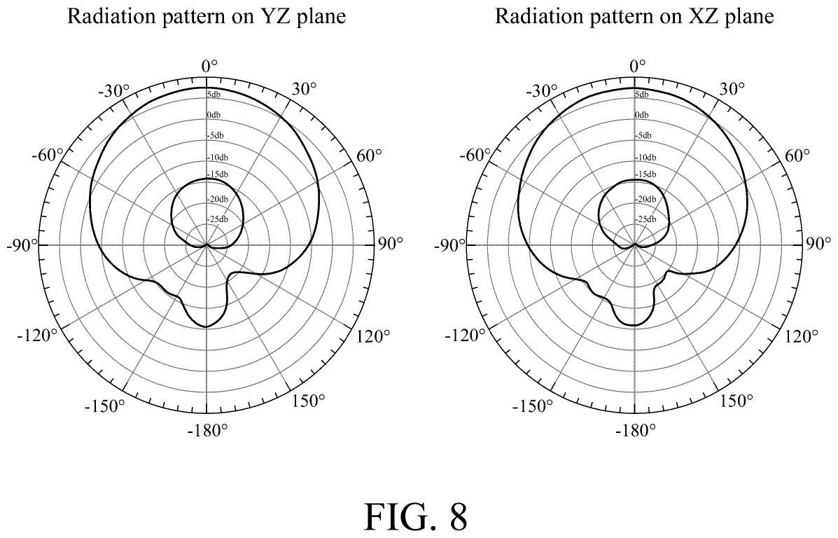

FIG. 8 depicts two plots respectively illustrating a radiation pattern of the magneto-electric dipole antenna 100 of this embodiment at a predetermined frequency of 19.5 GHz on a plane that is parallel to the first direction (X) and the third direction (Z), and a radiation pattern of the magneto-electric dipole antenna 100 of this embodiment at the predetermined frequency of 19.5 GHz on another plane that is parallel to the second direction (Y) and the third direction (Z), where a cross polarization discrimination (XPD) of the magneto-electric dipole antenna 100 is greater than 20 dB.

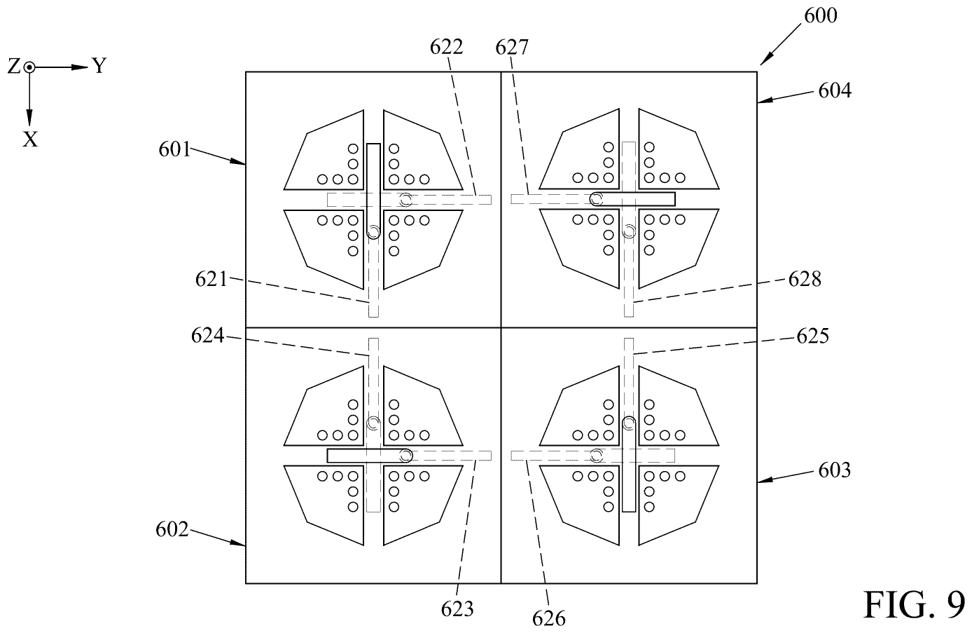

Referring to FIG. 9, an antenna array 600 according to an embodiment of the disclosure operates in the operating frequency band of 17.7 GHz to 21.2 GHz, and includes a first antenna 601, a second antenna 602, a third antenna 603 and a fourth antenna 604, each of which includes the magneto-electric dipole antenna 100 as mentioned above (see FIGS. 1 to 4). In this embodiment, a center of the second antenna 602 is aligned with a center of the first antenna 601 in the first direction (X), and the second antenna 602 is offset from the first antenna 601 in the counterclockwise direction by 90 degrees. A center of the third antenna 603 is aligned with the center of the second antenna 602 in the second direction (Y), and the third antenna 603 is offset from the second antenna 602 in the counterclockwise direction by 90 degrees. A center of the fourth antenna 604 is aligned with the center of the third antenna 603 in the first direction (X), and the fourth antenna 604 is offset from the third antenna 603 in the counterclockwise direction by 90 degrees.

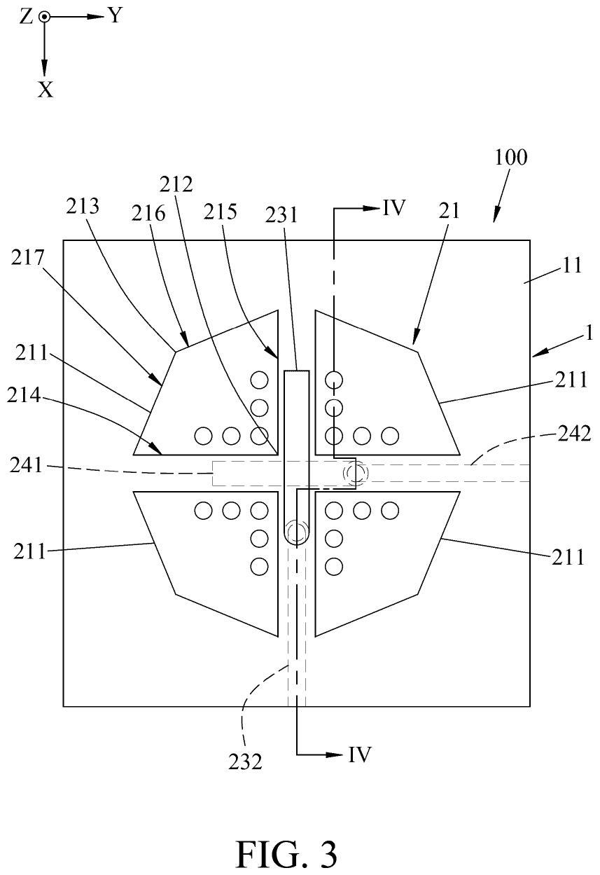

It should be noted that: the first antenna 601 includes a first input port 621 and a second input port 622 (respectively corresponding to the first feed-in line 232 and the second feed-in line 242 of the magneto-electric dipole antenna 100 (see FIG. 3) of the first antenna 601); the second antenna 602 includes a third input port 623 and a fourth input port 624 (respectively corresponding to the first feed-in line 232 and the second feed-in line 242 of the magneto-electric dipole in antenna 100 (see FIG. 3) of the second antenna 602); the third antenna 603 includes a fifth input port 625 and a sixth input port 626 (respectively corresponding to the first feed-in line 232 and the second feed-in line 242 of the magneto-electric dipole antenna 100 (see FIG. 3) of the third antenna 603); and the fourth antenna 604 includes a seventh input port 627 and an eighth input port 628 (respectively corresponding to the first feed-in line 232 and the second feed-in line 242 of the magneto-electric dipole antenna 100 (see FIG. 3) of the fourth antenna 604). Specifically, an amplitude and a phase of a signal received and emitted by each of the input ports 621-628 are listed in Table 2 as follows. It should be noted that a unit of the amplitude may be Watt, or may be a normalized amplitude.

TABLE 2

| | First | Second | Third | Fourth | Fifth | Sixth | Seventh | Eighth |
|---|---|---|---|---|---|---|---|---|
| | input | input | input | input | input | input | input | input |
| | port | port | port | port | port | port | port | port |
| Amplitude (W) | 1 | 1 | 1 | 1 | 1 | 1 | 1 | 1 |
| Phase (degrees) | 0 | 90 | 90 | 180 | 180 | 270 | 270 | 360 |

It should be further noted that, a distance between two geometric centers respectively of two adjacent ones of the antennas 601-604 is substantially equal to half of a wavelength of the target frequency.

In some embodiments, the center of the second antenna 602 is aligned with the center of the first antenna 601 in the first direction (X), and the second antenna 602 is offset from the first antenna 601 in the clockwise direction by 90 degrees. The center of the third antenna 603 is aligned with the center of the second antenna 602 in the second direction (Y), and the third antenna 603 is offset from the second antenna 602 in the clockwise direction by 90 degrees. The center of the fourth antenna 604 is aligned with the center of the third antenna 603 in the first direction (X), and the fourth antenna 604 is offset from the third antenna 603 in the clockwise direction by 90 degrees.

In some embodiments, the quantity of the magneto-electric dipole antennas 100 (see FIG. 3) of the antenna array 600 may be other than four (e.g., two, six, eight, or sixteen), where the magneto-electric dipole antennas 100 are arranged as an array (e.g., 2×1, 2×3, 2×4, or 4×4) according to user needs. Moreover, to prevent the magneto-electric dipole antennas 100 from interfering with each other, each of the magneto-electric dipole antennas 100 is configured such that polarizations of two adjacent ones of the magneto-electric dipole antennas 100 are orthogonal to each other.

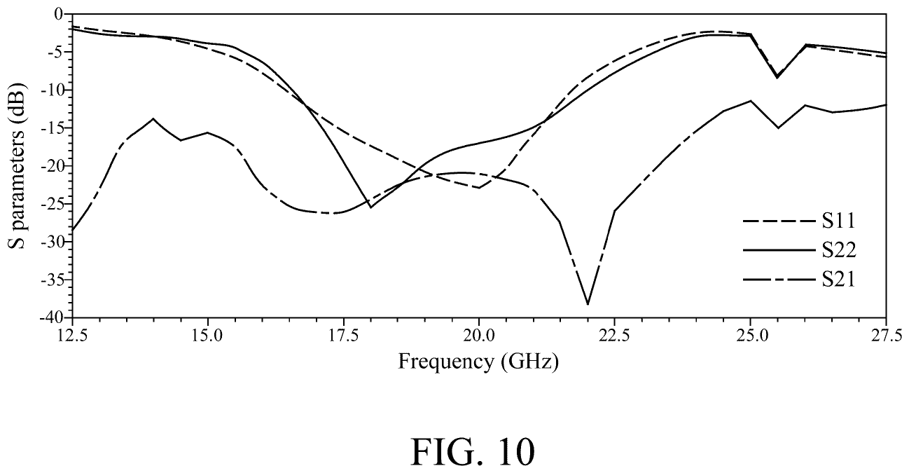

FIG. 10 is a plot illustrating scattering parameters (S11, S21, and S22) of the antenna array 600 of this embodiment in the predetermined frequency range of 12.5 GHz to 27.5 GHz. The scattering parameter (S11) is a reflection coefficient at the first input port 621, and is smaller than a target value of the scattering parameter (S11) (e.g., −10 dB) in the operating frequency band (i.e., 17.7 GHz to 21.2 GHz) of the antenna array 600. The scattering parameter (S21) is a transmission coefficient that is related to isolation between the first input port 621 and the second input port 622, and is smaller than a target value of the scattering parameter (S21) (e.g., −20 dB) in the operating frequency band of the antenna array 600. The scattering parameter (S22) is a reflection coefficient at the second input port 622, and is smaller than a target value of the scattering parameter (S22) (e.g., −10 dB) in the operating frequency band of the antenna array 600.

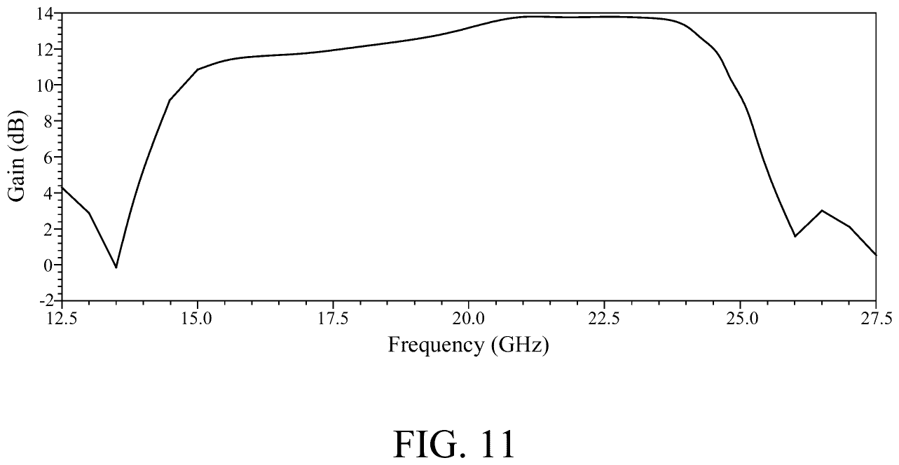

FIG. 11 is a plot illustrating a gain of the antenna array 600 of this embodiment in the predetermined frequency range (i.e., 12.5 GHz to 27.5 GHz), where the gain of the antenna array 600 is greater than 11 dB in the operating frequency band (17.7 GHz to 21.2 GHZ) of the antenna array 600.

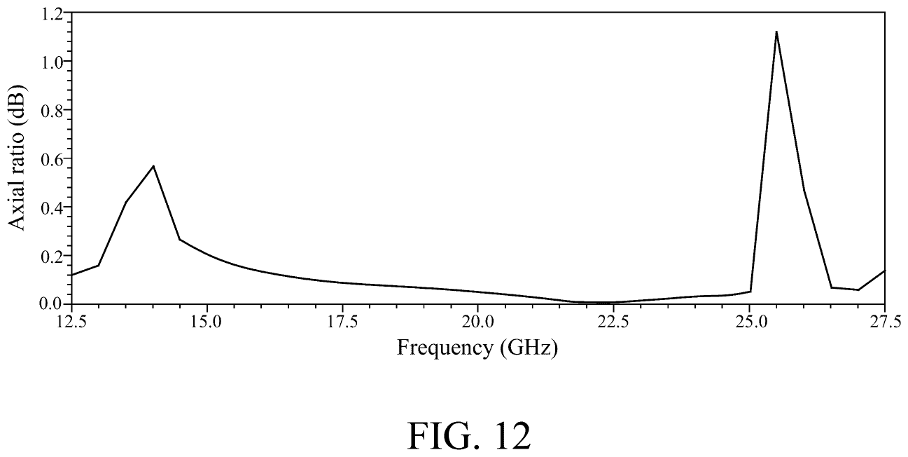

FIG. 12 is a plot illustrating an axial ratio of the antenna array 600 of this embodiment in the predetermined frequency range, where the axial ratio of this embodiment is smaller than 0.08 dB in the operating frequency band of the antenna array 600.

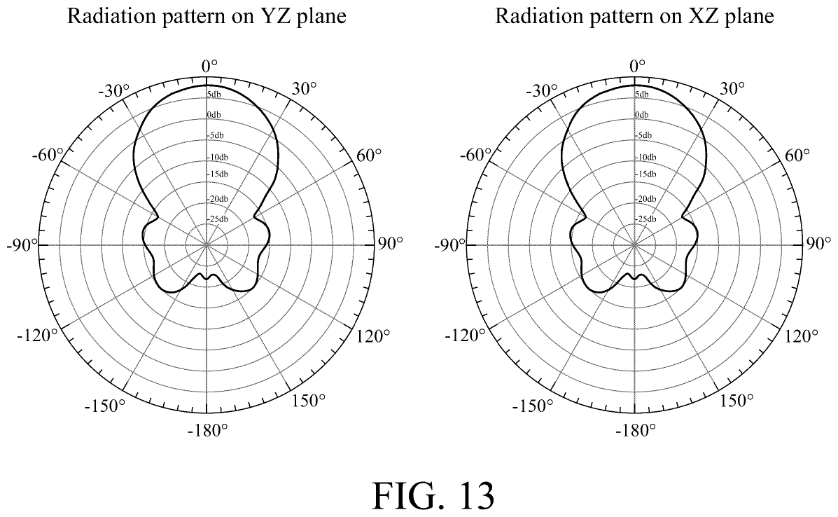

FIG. 13 depicts two plots respectively illustrating a radiation pattern of the antenna array 600 of this embodiment at a predetermined frequency of 19.5 GHz on a plane that is parallel to the first direction (X) and the third direction (Z), and a radiation pattern of the antenna array 600 of this embodiment at the predetermined frequency of 19.5 GHz on another plane that is parallel to the second direction (Y) and the third direction (Z), where a cross polarization discrimination (XPD) of the antenna array 600 is greater than 20 dB. It should be noted that the radiation patterns of the antenna array 600 of this embodiment are more symmetrical compared to the radiation patterns of a single magneto-electric dipole antenna 100 illustrated in FIGS. 1 to 4 (see FIG. 8).

In summary, according to the disclosure, the magneto-electric dipole antenna 100 that includes the first electric dipole component 21 and the second electric dipole component 22 can have a large bandwidth. Moreover, multiple magneto-electric dipole antennas 100 may be combined to form the antenna array 600, where the axial ratio is reduced and the effect of circular polarization is enhanced for the antenna array 600 compared to a single magneto-electric dipole antenna 100.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A magneto-electric dipole antenna comprising:
a substrate module including an upper surface, a lower surface, and a ground layer that is disposed between said upper surface and said lower surface; and
an antenna module including
a first electric dipole component that is disposed on said upper surface of said substrate module,
a second electric dipole component that is disposed between said upper surface and said ground layer in said substrate module,
a magnetic dipole component that is disposed between said upper surface and said ground layer in said substrate module, and that is electrically connected to said first electric dipole component, said second electric dipole component and said ground layer,
a first feed-in component that includes a first feed-in probe disposed on said upper surface of said substrate module, a first feed-in line disposed on said lower surface of said substrate module, and a first connecting element disposed in said substrate module and electrically connecting said first feed-in probe and said first feed-in line, and
a second feed-in component that includes a second feed-in probe disposed in said substrate module on a plane at which said second electric dipole component is disposed, a second feed-in line disposed on said lower surface of said substrate module, and a second connecting element disposed in said substrate module and electrically connecting said second feed-in probe and said second feed-in line.

2. The magneto-electric dipole antenna as claimed in claim 1, wherein:
said first electric dipole component includes four first patches that are divided into a first patch pair and a second patch pair;
two of said four first patches in said first patch pair are spaced apart and are arranged along a first direction that is parallel to said upper surface of said substrate module;
another two of said four first patches in said second patch pair are spaced apart and are arranged along the first direction;
said first patch pair and said second patch pair are spaced apart and are arranged along a second direction that is parallel to said upper surface of said substrate module and that is perpendicular to the first direction; and
said first feed-in probe is disposed between said first patch pair and said second patch pair.

3. The magneto-electric dipole antenna as claimed in claim 2, adapted for operation in a frequency range that includes a target frequency, wherein:
each of said four first patches includes a first corner and a second corner that align with an imaginary line which passes through a center point of said upper surface of said substrate module and which is parallel to said upper surface of said substrate module;
said first corner is closer to said center point of said upper surface of said substrate module than is said second corner; and
a distance between said first corner and said second corner is substantially equal to
$$\frac{c}{4 f \sqrt{{ε}_{r}}} ,$$
where “c” represents a speed of light, “f” represents the target frequency, and “εᵣ” represents a dielectric constant of the substrate module.

4. The magneto-electric dipole antenna as claimed in claim 3, wherein:
said first electric dipole component has a shape of an octagon;
each of said four first patches further includes a first edge and a second edge that are connected to each other through said first corner, and further includes a third edge and a fourth edge that are connected to each other through said second corner; and
for each of said four first patches, a first angle of said first patch at said first corner is equal to 90 degrees, and a second angle of said first patch at said second corner is equal to 135 degrees.

5. The magneto-electric dipole antenna as claimed in claim 2, wherein:
said second electric dipole component includes four second patches that are divided into a third patch pair and a fourth patch pair;
two of said four second patches in said third patch pair are spaced apart and are arranged along the second direction;
another two of said four second patches in said fourth patch pair are spaced apart and are arranged along the second direction;
said third patch pair and said fourth patch pair are spaced apart and are arranged along the first direction; and
said second feed-in probe is disposed between said third patch pair and said fourth patch pair.

6. The magneto-electric dipole antenna as claimed in claim 5, adapted for operation in a frequency range that includes a target frequency, wherein:
each of said four second patches includes a third corner and a fourth corner;
said third corner is closer to a center point of said upper surface of said substrate module than is said fourth corner; and
a distance between said third corner and said fourth corner is substantially equal to
$$\frac{c}{4 f \sqrt{{ε}_{r}}} ,$$
where “c” represents a speed of light, “f” represents the target frequency, and “εᵣ” represents a dielectric constant of the substrate module.

7. The magneto-electric dipole antenna as claimed in claim 1, wherein:
said first electric dipole component includes a plurality of first patches;
said second electric dipole component includes a plurality of second patches;
said magnetic dipole component includes a plurality of conducting rods that respectively correspond to said plurality of first patches, and that respectively correspond to said plurality of second patches; and
each of said plurality of conducting rods is perpendicular to said upper surface of said substrate module, extends in a direction away from said upper surface of said substrate module, and is electrically connected to a corresponding one of said plurality of first patches, a corresponding one of said plurality of second patches, and said ground layer.

8. The magneto-electric dipole antenna as claimed in claim 7, wherein:
each of said plurality of conducting rods is disposed at a vicinity of a first corner that is of the corresponding one of said plurality of first patches, and is disposed at a vicinity of a second corner that is of the corresponding one of said plurality of second patches, where said first corner is one of a plurality of corners of the corresponding one of said plurality of first patches that is the closest to a geometric center of said first electric dipole component, and said second corner is one of a plurality of corners of the corresponding one of said plurality of second patches that is the closest to a geometric center of said second electric dipole component.

9. The magneto-electric dipole antenna as claimed in claim 7, adapted for operation in a frequency range that includes a target frequency, wherein:
a length of each of said plurality of conducting rods is substantially equal to
$$\frac{c}{4 f \sqrt{{ε}_{r}}} ,$$
where “c” represents a speed of light, “f” represents the target frequency, and “εᵣ” represents a dielectric constant of said substrate module.

10. The magneto-electric dipole antenna as claimed in claim 1, wherein a geometric center of said first electric dipole component, a geometric center of said second electric dipole component, a geometric center of said first feed-in probe, and a geometric center of said second feed-in probe are aligned on an imaginary line that is perpendicular to said upper surface of said substrate module.

11. An antenna array, comprising:
a plurality of said magneto-electric dipole antennas as claimed in claim 1 that are arranged as an array, where polarizations of two adjacent ones of the plurality of said magneto-electric dipole antennas are orthogonal to each other.
